(19) United States
(12) Patent Application Publication
(10) Pub. No.: US 2016/0167207 A1
(43) Pub. Date: Jun. 16, 2016

(54) POWER WRENCH ATTACHMENT

(71) Applicant: John A. Badiali, Englewood, FL (US)

(72) Inventor: John A. Badiali, Englewood, FL (US)

(21) Appl. No.: 15/050,826

(22) Filed: Feb. 23, 2016

Related U.S. Application Data
(62) Division of application No. 13/789,740, filed on Mar. 8, 2013.
(60) Provisional application No. 61/608,976, filed on Mar. 9, 2012.

(51) Int. Cl. B25B 21/00

(52) U.S. Cl. CPC B25B 21/007

(57) ABSTRACT

An attachment including open end box wrench adapted to be attached to and to be driven by a power tool though an input gear of the attachment, the input gear driving an output gear and the wrench

### CROSS-REFERENCE TO RELATED APPLICATIONS

This application is a divisional application of U.S. patent Ser. No. 13/789,740 filed Mar. 8, 2013 and claims priority of United States Provisional Patent Application Ser. No. 61/608,976, filed Mar. 9, 2012, which is incorporated herein by reference.

### FIELD OF THE INVENTION

The present invention relates to attachments for power tools, in particular powered ratchet wrenches.

### BACKGROUND OF THE INVENTION

Power tools have heretofore have been used to drive sockets for driving and removing fasteners. While such power tools provide increased efficiency and torque for fastener applications, frequently their construction is bulky and too large and clumsy to use in confined areas such as an engine compartment or vehicle suspension, and machinery works.

In addition the inherent design of a conventional ratchet head, both manual and powered, with its square drive and hex socket assembly does not allow for use on a stud and nut fastener in which the male threaded portion protrudes through the nut to a length which is greater than the depth of the particular socket being utilized, inhibiting the engagement of the socket to the nut.

Some inventors have indeed recognized this problem with such tools and have designed specially configured ratchet heads which provide an open drive gear which will allow for a long stud to pass through it for such applications. And they have configured special hollow “pass-through” drive sockets for use with such heads.

The vast majority of these “pass-through” ratchets are manually operated box ratchet hand tools. The available few such dedicated air wrenches that are powered are of limited production making them inordinately more expensive than their conventional non pass-through counterparts. And these few are very bulky and thick, and restrictive for use in confined or low profile areas.

### SUMMARY OF THE INVENTION

The present invention provides an inexpensive tool attachment which can convert any standard power ratchet wrench into a low profile, pass-through powered box wrench output. The present invention also provides a universal means of attachment to the power ratchet that is quick and easily detachable, and requires no modification to the existing tool, The attachment of the present invention can accept a variety of currently available dedicated socket sizes. The attachment can be adjusted and fixed to various angular positions relative to the tool, to enable use of the tool in confined and hard to reach fastener locations.

### BRIEF DESCRIPTION OF THE DRAWINGS

FIG. 1 is a perspective view illustrating how a preferred power wrench attachment of the present invention attaches to a conventional power tool;

FIG. 2 is a top plan view illustrating angular attachments between the power tool and the power wrench attachment of the present invention;

FIG. 3 is a view showing the power wrench attachment of the present invention with the housing in phantom to show the gears contained within the housing;

FIG. 4 illustrates another embodiment of the power wrench attachment of the present invention providing angular attachment to a power wrench;

FIG. 5 illustrates another embodiment of the power wrench attachment of the present invention in the form of a power wrench attachment with an upwardly angled end portion, and;

FIG. 6 illustrates the power wrench attachment of FIG. 5 attached to a powered driver.

### DETAILED DESCRIPTION OF THE PREFERRED EMBODIMENTS

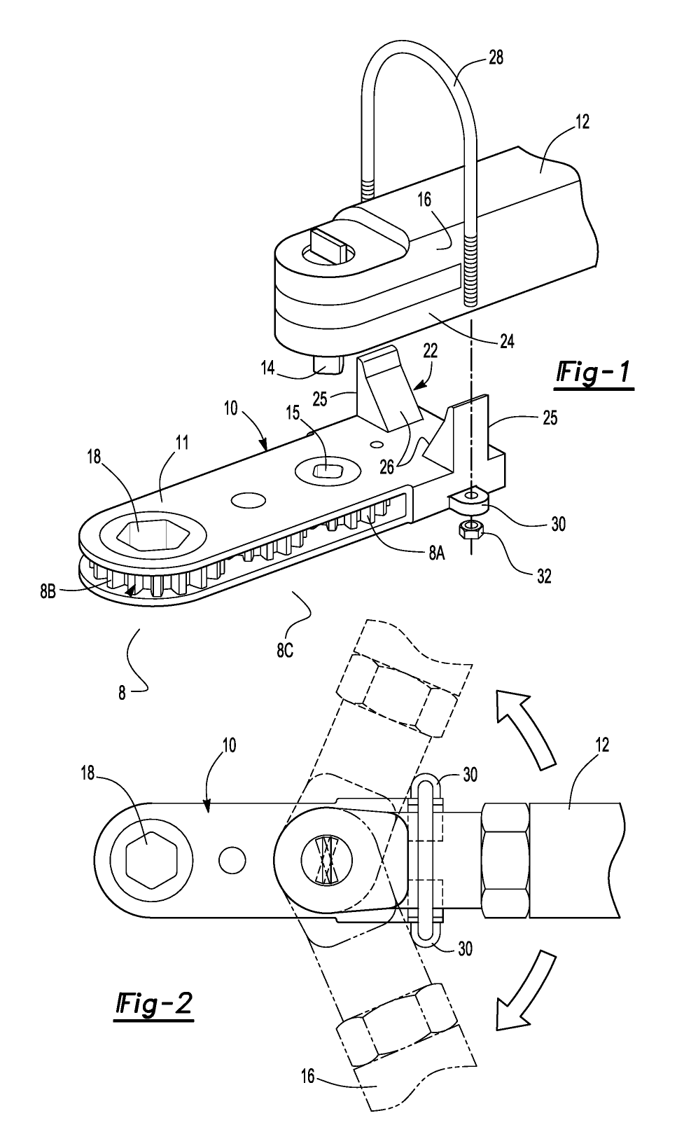

As can best be seen in FIG. 1 a power wrench attachment 10 of the present invention is shown as attachable to a conventional power wrench 12 by insertion of the output power shaft 14 of the power wrench 12 into an input bore 15 of the power wrench attachment 10. The power wrench 12 is locked to the attachment 10 to prevent unwanted rotation between the attachment 10 and the wrench 12 during use. The wrench 12 is fitted into a cradle 22 projecting upwardly from the attachment 10. The cradle 22 is formed to accommodate and to receive the sides 24 of the wrench 12. The cradle 22 is formed with opposing projections 25 having inwardly angled faces 26 which accommodate the sides 24 of the wrench 12. A U-bolt 28 extends over the wrench 12 and extends through projections 30 formed on the sides of the attachment 10. Nuts 32 for the threaded ends of the U-bolt 28 provide the means to securely lock the attachment 10 to the wrench 12.

FIG. 2 illustrates a power wrench 12A, of a different configuration than the power wrench 12 of FIG. 1 attached to the powered wrench attachment 10 only by the power wrench output power shaft 14 and the power wrench attachment input bore 15. (See FIG. 1) This permits the angle between the power wrench 12 and the attachment 10 to be adjusted to reach difficult positions between the wrench 12 and the fastener to be driven.

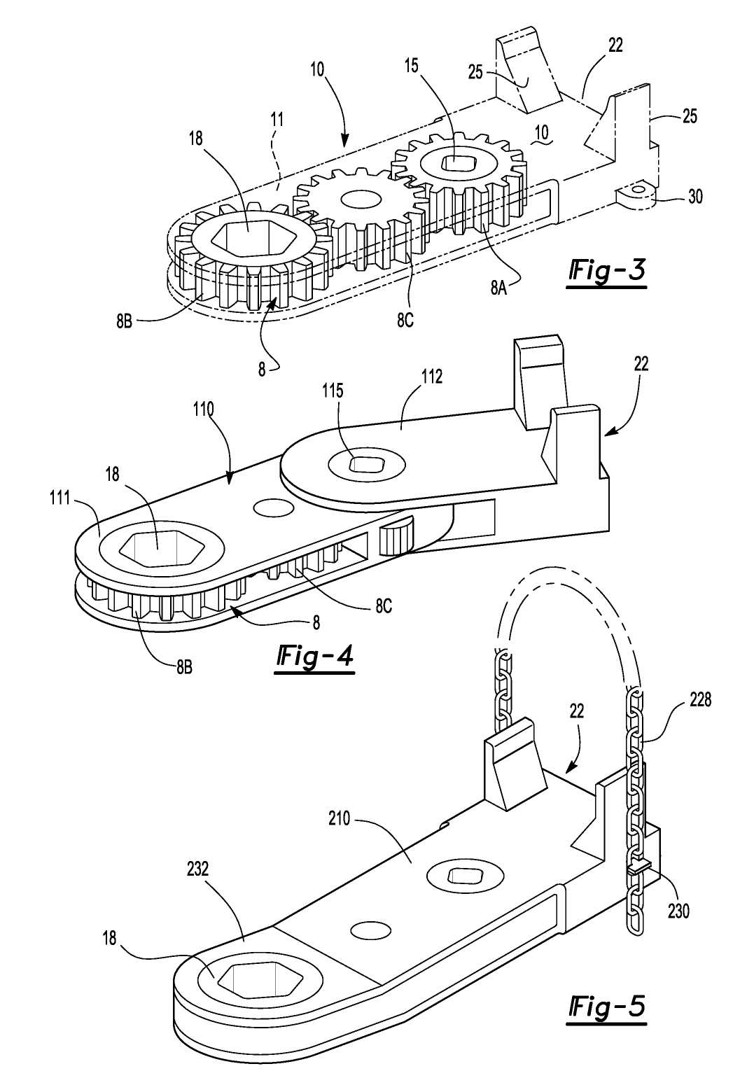

As best seen in FIG. 3 the power wrench attachment 10 consists of a set of pinion gears 8 arranged in a linear fashion in a containment housing 11 with the external design emulating the look of a typical ratchet box wrench end. In the preferred construction an input gear 8A drives an output gear 8B through an intermediate gear 8C.

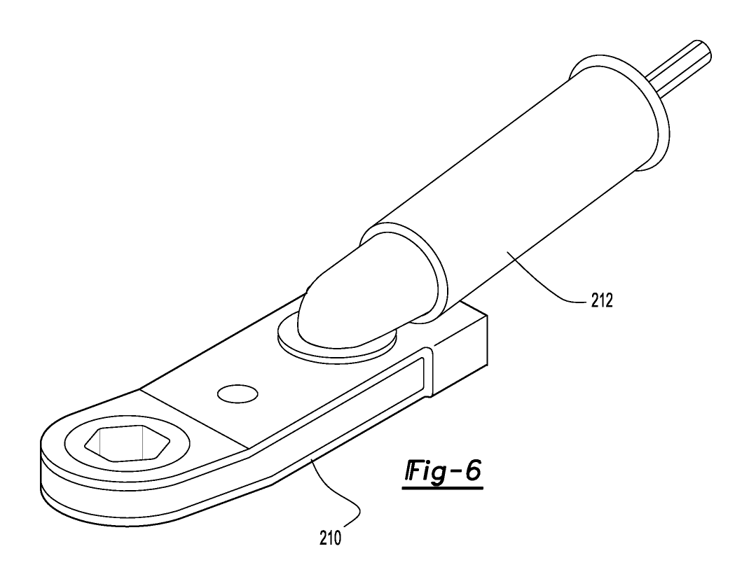

A minimum of two meshed hubbed gear units or the preferred three unit gear train may be employed. More gears can be used up to as many total gears as may be required to match any desired housing length. And the gears may be arranged in a straight line or at an acute angle offset up from power wrench axis as shown in FIG. 5.

The bore 15 of the input pinion gear 8A would match the square drive output shaft 14 of the particular power wrench 12 (typically ¼, ⅜″, or ½″ square), and an output bore 18 of the output gear 8B would generally be of hexagonal design or any other internal shape configuration as may be required to fit a particular maker's sockets (not shown) or special fastener shapes and designs.

It should be apparent that the power shaft 14 of the power wrench 12 fits within the input bore 15 of the attachment 10 to drive the out put bore 18 through the gears 8. Sockets or the like (not shown) can be attached to the output bore of the 18 of the attachment in a conventional manner to be driven within the power wrench 12.

The housing 11 of the power wrench attachment of the present invention may be of riveted flat stock, in open or closed construction, or alternatively and preferably of forged, die cast or molded metal closed construction and secured together by any suitable mechanical fastening means and finished to suit.

FIG. 4 illustrates another preferred configuration of the power wrench attachment indicated by reference numeral 110. The power wrench attachment 110 is constructed of two pieces with a housing 111, one end of which is received within a housing 112 which contains the yoke 22. The housing 111 contains the gears 8 and is pivotally connected to the housing 112 at the input bore 115. The input bore 115 is adapted to receive the output power shaft 14 of the power wrench 12 (not shown). The output power shaft 14 of the power wrench 12 drives the output bore 18 though the gears 8. The pivotal connection between the housing 111 and the housing 112 permits the output 18 to be angularly offset with respect to the power shaft 14 of the power wrench 12 to again enable the attachment to reach difficult positions.

FIG. 5 illustrates an embodiment of the present wrench attachment 210 having an end 232 of the housing 10 extending angularly upwardly with respect to the rest of the housing 211. The housing 211 houses the output gear 8B (not shown) to also extend angularly with respect to the input gear 8A (not shown). FIG. 5 also illustrates a modified means for attaching the power wrench 12 to the power wrench attachment 210. A chain 228 and locking projections 230 replace the U-bolt 28 and projections 30 of the FIG. 1 embodiment of the present invention.

FIG. 6 illustrate the power wrench attachment 210 of FIG. 5 attached to a power drill attachment 212 rather than the power wrench 12 of FIG. 1.

While the attachment of the present invention has been described as being used with a power wrench 12 it should be apparent that other power tools such as a drill motor with a conventional socket wrench drive attachment could be used in place of the power wrench.

While the pass through concept is not new, a separate accessory design that adapts to any standard power tool has not been heretofore provided.

1. A wrench attachment to be driven by a power tool comprising:
a housing;
an input gear for attachment to said power tool carried by said housing; and
an output gear carried by said housing and drivingly connected to said input gear to rotate upon rotation of said input gear;
said output gear including a open wrench portion to be rotated by said output gear; and
said output gear being angularly offset with respect to said input gear.

2. The wrench attachment as defined in claim 1 and in which said output gear is angularly adjustable with respect to the axis of rotation of said input gear.

3. The wrench attachment as defined in claim 1 and including an intermediate gear connecting said input gear to said output gear.

4. The wrench attachment as defined in claim 1 and including a clamp removably clamping the wrench attachment to the power tool.

5. A wrench attachment to be driven by a power tool comprising:
a housing;
an input gear for attachment to said power tool carried by said housing; and
an output gear carried by said housing and drivingly connected to said input gear to rotate upon rotation of said input gear;
a second housing mounted to said first mentioned housing to permit angular adjustment between said housing; and
said power tool being removably mounted to said second housing.

6. A wrench attachment to be driven by a power tool comprising:
a housing;
an input gear for attachment to said power tool carried by said housing; and
an output gear carried by said housing and drivingly connected to said input gear to rotate upon rotation of said input gear; and
said housing being angled between said output gear and said input gear.
